(19) United States
(12) Patent Application Publication
(10) Pub. No.: US 2006/0023364 A1
(43) Pub. Date: Feb. 2, 2006

(54) Head supporting mechanism for magnetic disk device and connecting method thereof

(75) Inventor: Takeshi Ohwe, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 10/992,836

(22) Filed: Nov. 22, 2004

(30) Foreign Application Priority Data
Jul. 30, 2004 (JP) 2004-223698

(51) Int. Cl. G11B 5/48; G11B 21/16

(52) U.S. Cl. 360/245.9

(57) ABSTRACT

A head supporting mechanism having a structure for connecting a first end of a suspension side wire, the other end thereof being connected to a magnetic head of a disk apparatus, to a circuit of a disk device via a flexible circuit board is provided, without using solder containing lead so that the both are easily disconnected during repair. A tail terminal (2) provided at the one end of the suspension side wire is disposed to be in surface-contact with a bonding pad (1) of the flexible circuit board (10) and bonded to the latter via a gold ball (6).

### BACKGROUND OF THE INVENTION

1. Field of the Invention

The present invention relates to a head supporting mechanism for a magnetic disk device and a method for the connection of portions of a head wire distribution, particularly to a distribution structure for the electric connection of a writing head element and a reading head element of a magnetic head via a suspension, i.e., a structure for electrically connecting a suspension-side tail terminal with a bonding pad of a flexible printed circuit board (FPC) and a method for executing this connection.

2. Description of the Related Art

In the prior art, as shown in FIG. 7, a magnetic head slider 30 mounting thereon a writing head element and a reading head element is attached in an inclinable manner to a flexure portion formed at a tip end of a gimbal spring of a suspension 32 and flies slightly above a surface of a rotating magnetic disk 34, wherein information is recorded, onto the magnetic disk 34, by the writing magnetic head element or regenerated, from the magnetic disk 34, by the reading magnetic head element.

In this regard, in FIG. 7, reference numeral 36 denotes a spindle which is a rotary shaft for a group, for example, of four magnetic disks 34 attached thereto at a predetermined gap between the adjacent ones and rotates together with the four magnetic disks 34 by a spindle motor (not shown). Reference numeral 38 denotes a head arm of an actuator, which is pivoted about a shaft 40 and has a coil 42 on a side opposite to the suspension to be rotated on the shaft 40 by a voice coil motor 44 so that a magnetic head slider 30 moves in the radial direction or the seeking direction relative to the magnetic disk 34.

FIG. 8 illustrates a structure of the head actuator including the suspension 32, the head arm 38, the coil 42 or others, and FIG. 9 illustrates a structure in which the magnetic head slider 30, the suspension 32 and a printed circuit board 12 are integral with each other.

As shown in FIG. 8, the head actuator of the magnetic disk device consisting for example, of the four magnetic disks 34, has five head arms 38 arranged generally parallel to each other wherein each of the uppermost and lowermost head arms 38 carries one head slider 30, and each of three intermediate head arms 38 carries two head sliders 30. The head slider 30 carried on the uppermost head arm 38 corresponds to an upper surface of the uppermost magnetic disk 34, the head slider 30 carried on the lowermost head arm 38 corresponds to a lower surface of the lowermost magnetic disk 34. The magnetic heads carried on the three intermediate head arms 38 correspond to a lower surface of the uppermost magnetic disk 34, upper and lower surfaces of the two intermediate magnetic disks 34, and an upper surface of the uppermost magnetic disk.

As shown in FIG. 9, a terminal electrode for the writing magnetic head element or a terminal electrode for the reading magnetic head element is connected to the printed circuit board 12 integrally adhered to the suspension 32, and the printed circuit board 12 extends rearward from the suspension 32 to a front end forming a tail terminal 14.

The respective printed circuit board 12 includes total four wires formed on a flexible resinous substrate of polyimide or others; two wires for the writing magnetic head element and other two wires for the reading magnetic head element in the respective head slider; and are integrally adhered to the suspension 32 formed of a thin stainless steel sheet. The printed circuit board 12 is connected at one end to the writing magnetic head element and the reading magnetic head element carried on the head slider 30, and extends rearward from the suspension 32 at the other end through a groove provided on a lateral side of the respective head arm 12 to the tail terminal 14 which is connected to the bonding pad of the FPC 10 fixed on the lateral side of the actuator. Thereby, in the tail terminal 14 (2), four leads are arranged in parallel to each other while being stripped off from the flexible resinous substrate or projected from a front end of the flexible resinous substrate.

The FPC 10 includes a number of wires formed on a flexible resinous substrate, such as polyimide, in the same manner as the printed circuit board 12, that is, as shown in FIG. 10, there are wires corresponding to the writing magnetic head elements and the reading magnetic head elements of all the head sliders 30 mounted on the actuator. Accordingly, if eight magnetic head sliders are provided, thirty two wires are formed in total. As shown in FIG. 8, the FPC 10 is fixed at one end thereof to a lateral side of the actuator and is electrically connected at the other end thereof to a semiconductor device 14 on the printed circuit board 12 fixed in the disk device as shown in FIG. 7. As the FPC 10 is flexible and extends from the lateral side of the actuator to the printed circuit board 12 in a curved manner, the head arm 38 of the actuator is swingable in the seeking direction. The bonding pads 1 are formed at an end of the FPC 10 closer to the actuator, for the connection with the tail terminals 14 (2) on the suspension side.

In the prior art, the connection of the tail terminal on the suspension side with the bonding pad on the FPC 10 side has been generally carried by using solder. That is, as shown in FIG. 10, when four tail terminals 2 on the suspension side are connected with the corresponding bonding pads 1 on the FPC 10, methods have been employed wherein they are opposed to each other and heated to melt solder preliminarily coated on the surface of the tail terminal 2 or the bonding pad 1, or wherein they are located to make an angle of about 90° between them and heated by a bonding chip or light beam to melt solder preliminarily coated on one or both of surfaces thereof.

According to the above-mentioned connecting methods known in the prior art, the solder used therefor generally has contained lead. In view of the environmental problem, it is expected that the use of lead-containing solder will be strictly restrained in future. At present, however, the melting point of the non-lead solder is high to be liable damage the bonded portion of the suspension side, or the FPC side. Further, a considerable time is necessary for melting the non-lead solder, whereby it is impossible to reduce the tactile time during the mass-production.

Accordingly, an ultrasonic bonding of gold has recently been used, wherein the surfaces of the suspension side tail terminal and the FPC side bonding pad are coated with gold. Such prior art connecting methods will be explained with reference to FIGS. 11 to 14.

In FIG. 11, when the FPC side bonding pad 1 and the suspension side tail terminal 2 are connected together, solder (not shown) is preliminarily coated on a terminal surface of one or both of them and molten by heat to connect the both to each other.

Example shown in FIG. 12 is basically the same as that shown in FIG. 11. However, there is only one difference between Examples shown in FIGS. 11 and 12 in that, while an end edge surface of the suspension side tail terminal 2 is placed on the FPC side bonding pad 1 in FIG. 11, the suspension side tail terminal 2 completely passes over the FPC side bonding pad 1 in FIG. 12.

FIG. 13 illustrates one Example of the prior art connecting methods using ultrasonic bonding, wherein a horn 3 of an ultrasonic bonding device is used for pressing the suspension side tail terminal 2 onto the FPC side bonding pad 1 to heat the tail terminal 2 by the ultrasonic vibration of the horn 3 in the direction perpendicular to the longitudinal direction of the tail terminal 2.

FIG. 14 illustrates another Example of the prior art connecting methods using ultrasonic bonding wherein there is only one difference, between Examples shown in FIGS. 13 and 14 in that, while the end edge surface of the suspension side tail terminal 2 is placed on the FPC side bonding pad 1 in FIG. 13, the suspension side tail terminal 2 completely passes over the FPC side bonding pad 1 in FIG. 14. In either cases, the horn 3 emits ultrasonic vibration in the direction shown by an arrow and heats the both to connect them each other.

However, according to the above-mentioned prior art connecting methods using the ultrasonic bonding, if a disconnection is required, it is necessary to weaken the connection by heat and ultrasonic vibration and finally pull up the suspension side tail terminal from the FPC, which is a troublesome operation.

According to the above-mentioned prior art wherein the FPC side bonding pad 1 and the suspension side tail terminal 2 are connected to each other, when the connection is carried out by using non-lead solder, a time required for melting the solder is too long to reduce the tact time during the mass production. On the other hand, according to the prior art using the ultrasonic bonding, if a disconnection is required for the purpose of repair or others, it is necessary to weaken the connection by heat and ultrasonic vibration, which is a troublesome operation.

### SUMMARY OF THE INVENTION

An object of the present invention is to provide a head supporting mechanism for a magnetic head device having a structure for connecting the suspension side tail terminal with the FPC side bonding pad, capable of easily disconnecting them from each other when the repair or others is carried out, while taking care of the environmental problem, and a method for connecting wires in such a manner.

To achieve the above object, according to the present invention, there is provided a head supporting mechanism for a magnetic disk device comprising: a magnetic head; a circuit of the disk device; a flexible circuit board; a suspension side wire having a first end connected to a magnetic head and a second end connected to the circuit of the disk device via the flexible circuit board; and the suspension side wire provided at the second end thereof with a tail terminal disposed to be in surface-contact with a bonding pad of the flexible circuit board and bonded to the latter via a gold ball.

In this case, the gold ball bonding is positioned so as to be bridging the upper surfaces of the suspension side tail terminal and the bonding pad of the flexible circuit board with each other.

Also, according to the present invention, a method is provided, for connecting a first end of a suspension side wire, the second end thereof being connected to a magnetic head, to a circuit of a magnetic disk device via a flexible circuit board, characterized in that a tail terminal provided at the one end of the suspension side wire is disposed to be in surface-contact with a bonding pad of the flexible circuit board, and a gold ball is pressed onto a step between the both, while applying a force slanted toward the tail terminal to the gold ball relative to the vertical direction of the surface of the bonding pad.

Further, according to the present invention, a method is provided, for connecting a first end of a suspension side wire, the second end thereof being connected to a magnetic head, to a circuit of a magnetic disk device via a flexible circuit board, characterized in that a tail terminal provided at the one end of the suspension side wire is disposed to be in surface-contact with a bonding pad of the flexible circuit board, and a gold ball is pressed onto a step between the both, while applying a force to a position different from a previously bonded position.

### BRIEF DESCRIPTION OF THE DRAWINGS

FIGS. 1(a) and 1(b) illustrate an embodiment of a structure for connecting the suspension side tail terminal with the flexible printed circuit board (FPC) side bonding pad according to the present invention;

FIGS. 2(a) and 2(b) illustrate another embodiment of the inventive connecting structure;

FIGS. 3(a) to 3(c) illustrate further embodiments of the inventive connecting structure;

FIGS. 4(a) and 4(b) illustrates furthermore embodiment of the inventive connecting structure;

FIGS. 5(a) and 5(b) illustrate still further embodiment of the inventive connecting structure;

FIGS. 6(a) and 6(b) illustrate a still furthermore embodiment of the inventive connecting structure;

FIG. 7 is a plan view of a magnetic disk device to which the inventive head supporting mechanism is applicable;

FIG. 8 is a perspective view of a head actuator;

FIG. 9 is a plan view of a suspension assembly;

FIG. 10 is a diagrammatic plan view showing the connection between suspension side tail terminals and a flexible printed circuit board side bonding pads;

FIG. 11 illustrates one example of a prior art connecting structure;

FIG. 12 illustrates another example of a prior art connecting structure;

FIG. 13 illustrates a further example of a prior art connecting structure; and

FIG. 14 illustrates a furthermore example of a prior art connecting structure;

### DETAILED DESCRIPTION OF THE PREFERRED EMBODIMENTS

The preferred embodiments of the present invention will be described in more detail below with reference to the attached drawings.

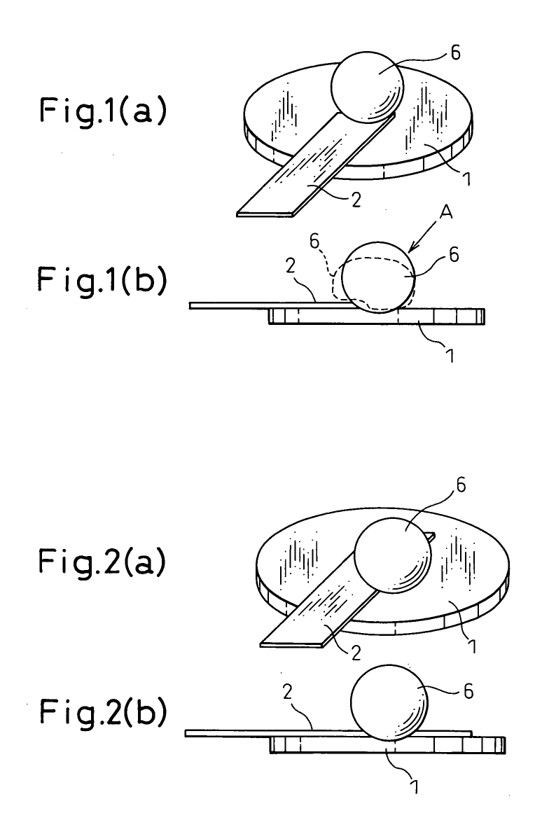

FIG. 1(a) is a plan view illustrating a first embodiment of the present invention and FIG. 1(b) is a front view thereof. In FIGS. 1(a) and 1(b), reference numeral 6 denotes a gold ball. This embodiment is structured so that a front end surface of a suspension side tail terminal 2 touches a flexible printed circuit board (FPC) 10 side bonding pad 1; that is, a front end surface of the tail terminal 2 is brought into surface-contact with the surface of the bonding pad 1; and the front end surface of the tail terminal 2 is positioned at a middle portion of the bonding pad 1. Also, the gold ball 6 is fixed to a longitudinal front end of the suspension side tail terminal 2 by an ultrasonic bonding.

When the ultrasonic bonding is executed while using the gold ball 6, as shown by an arrow A in FIG. 1(b), the gold ball 6 located in a step between the longitudinal front end edge of the suspension side tail terminal 2 and the bonding pad 1 is applied with a pressure directed obliquely toward the tail terminal 2 relative to the vertical direction of the bonding pad 1, so that the gold ball 6 formed of a gold wire fed from a capillary of the bonding device deforms as shown in FIG. 1(b) by a broken line and rides from the surface of the bonding pad 1 to the surface of the tail terminal 2. Thus, the both are connected with each other via the gold ball 6.

By interposing the gold ball 6 between both 1 and 2, trouble generating when the two are disconnected from each other is eliminated to a great extent. That is, according to the prior art method, it is necessary to heat the two and apply the ultrasonic wave thereto, and finally pull up the suspension side tail terminal 2, for example, from the flexible printed circuit board, which is a troublesome operation.

According to this embodiment of the present invention, when 1 and 2 are to be disconnected from each other, the gold ball 6 is pulled up by using a tool (not shown), whereby the two are easily released from the fixation.

In the embodiment shown in FIGS. 1(a) and 1(b), as the gold ball 6 is located on the extension of the suspension side tail terminal 2, there is an advantage in that the widthwise dimension of the tail terminal 2 is easily restricted. On the other hand, in this embodiment, unless the width of the suspension side tail terminal 2 is sufficiently large, there is a risk in that a contact area with the gold ball 6 becomes too small and, as a result, the gold ball 2 cannot be firmly bonded. When the step exists between the tail terminal 2 and the bonding pad 1 as in the embodiment of FIG. 1, it is possible to ensure the reliability by applying a load in the direction shown by the arrow A; that is, slightly oblique toward the tail terminal 2 positioned on a higher step so that the bonding strength increases.

FIG. 2(a) illustrates a perspective view of a second embodiment of the present invention and FIG. 2(b) is a front view thereof. In FIGS. 2(a) and 2(b), reference numeral 6 denotes a gold ball. Also in the second embodiment, a front end of the suspension side tail terminal 2 is arranged to be in contact with the FPC 10 side bonding pad 1 in the same manner as in the first embodiment. However, in this embodiment, the gold ball 6 is fixedly connected to either one of widthwise lateral surfaces of the tail terminal 2 by the ultrasonic bonding while being located in a step between the tail terminal 2 and the bonding pad 1. In the same manner as in the first embodiment, the gold ball 6 is applied with a pressure to deform the gold ball 6 itself due to the ultrasonic bonding during the connection.

According to the second embodiment, since the gold ball 6 is fixed to the widthwise lateral surface of the suspension side tail terminal 2, it is possible to obtain a sufficient area in the tail terminal 2 for the contact with the gold ball 6 irrespective of a width of the suspension side tail terminal 2. Accordingly, in comparison with the embodiment shown in FIG. 1, the bonding area of the gold ball 6 is enlarged to further enhance the reliability of the connection.

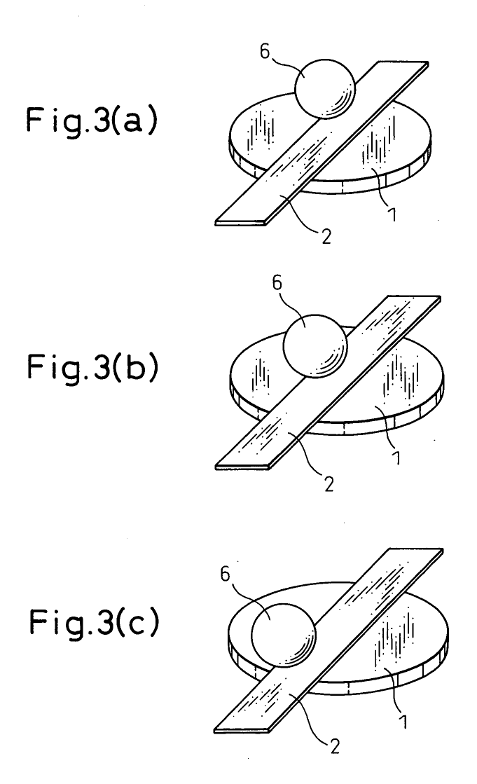

FIGS. 3(a) to 3(c) illustrate third embodiment wherein the bonding position of the gold ball 6 is variously changed. According to this embodiment, the suspension side tail terminal 2 is located to completely pass over the bonding pad 1 so that the tail terminal 2 is brought into surface-contact with the surface of the bonding pad 1. In the same manner as in the embodiment of FIGS. 2(a) and 2(b), the gold ball 6 is bonded to either one of widthwise lateral surfaces of the tail terminal 2 by the ultrasonic bonding.

In FIG. 3(a), the gold ball 6 is placed in the opposite side portion of the FPC 10 side bonding pad 2; in FIG. 3(b), the gold ball 6 is placed in a central portion of the bonding pad 2 in the flexible printed circuit board; and in FIG. 3(c), the gold ball 6 is placed in this side portion of the FPC 10 side bonding pad 1.

By changing the position of the gold ball 6, the surfaces of the suspension side tail terminal 2 and the FPC 10 side bonding pad 1 are always fresh even if the suspension side tail terminal 2 and the FPC 10 side bonding pad 1 are bonded together several times, whereby it is possible to repeat the repair a plurality of times.

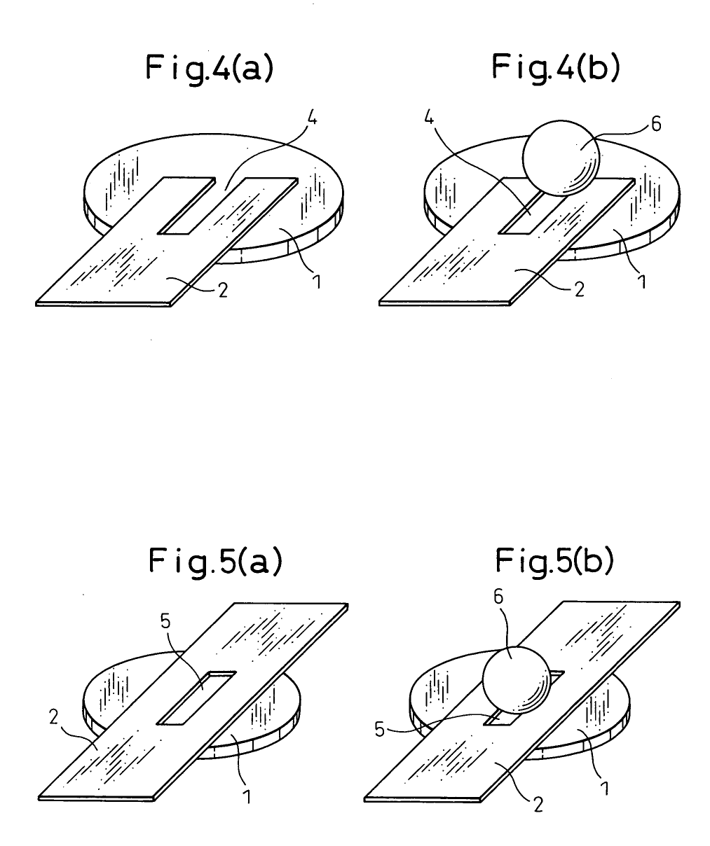

FIGS. 4(a) and 4(b) illustrate further embodiment of the present invention. First, as shown in FIG. 4(a), a slit 4 is provided in the suspension side tail terminal 2. This slit 4 is a so-called open slit which opens at one end of the tail terminal 4. Next, as shown in FIG. 4(b), the tail terminal 2 is fixed to the FPC 10 side bonding pad 1 via the gold ball 6 placed on the tail terminal 2 while bridging the slit 4. As the gold ball 6 is fixed to the bonding pad 1 while bridging the slit 4, it is possible to prolong the length of the gold ball 6 bonded to the step between the tail terminal 2 and the bonding pad 1, and thus increase the bonding strength between 1 and 2.

FIGS. 5(a) and 5(b) illustrate still further embodiment of the present invention. As shown in FIG. 5(a), a slit 5 is provided on a lengthwise center line of the suspension side tail terminal. This slit 5 is a so-called closed slit which is not open to an end or lateral surface of the tail terminal 2. In FIG. 4(b), the gold ball 6 is fixed to the FPC 10 side bonding pad 1 while bridging the slit. According to such a structure, even if a width of the suspension side tail terminal 2 is large, it is not fixed to the gold ball 6 on one side of the tail terminal 2 but is bonded thereto at a widthwise center of the tail terminal 2 as shown in FIG. 5(b), whereby the bonding reliability against disturbance such as vibration is improved.

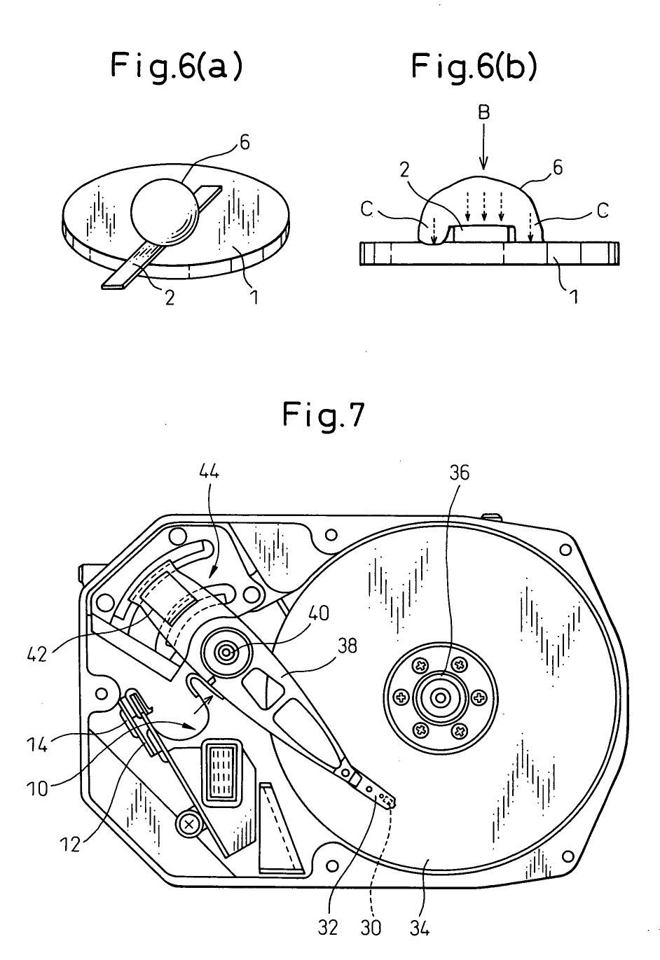

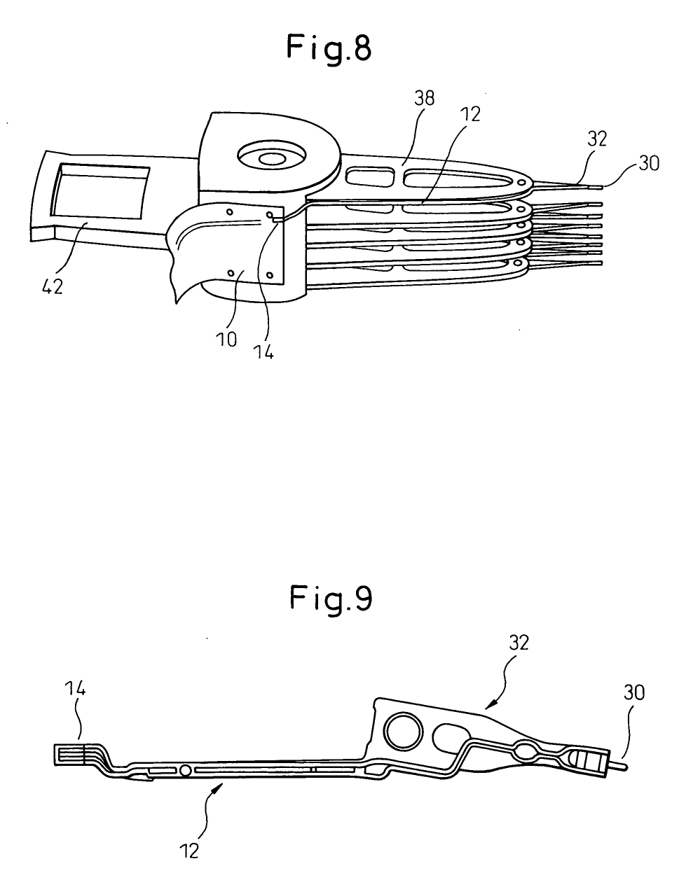

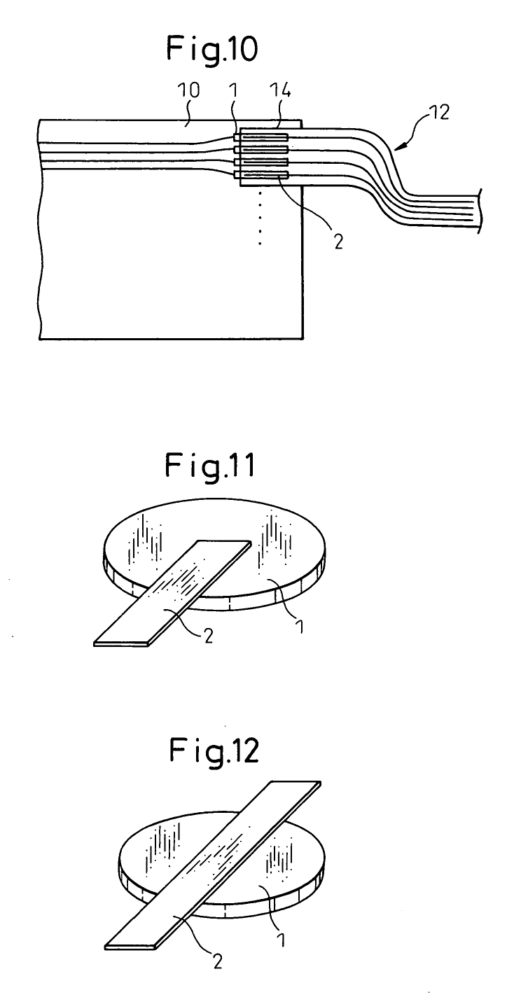

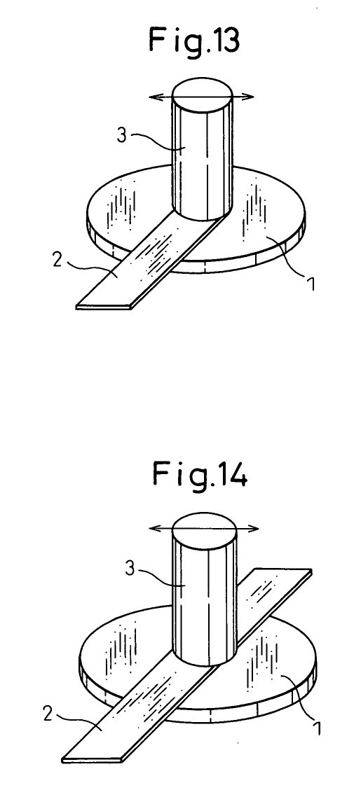

FIGS. 6(a) and 6(b) illustrate still furthermore embodiment of the present invention. According to this embodiment, the gold ball 6 having a width larger than that of the tail terminal 2 is used for the bonding, wherein a load is applied to strike the gold ball 6 from directly above the tail terminal 2 as shown in an arrow B. In this case, there is a drawback in that a sufficient bonding force between the gold ball 6 and the bonding pad 1 is not obtained because the load C applied to the tail terminal 2 is small. Accordingly, as shown by an arrow A in FIG. 1(b), it is important that the load is applied to the gold ball 6 with a slight inclination.

The preferred embodiments of the present invention have been described above with reference to the attached drawings. The present invention should not be limited thereto but may be variously changed or modified without departing from a spirit or scope of the present invention.

For example, while the FPC 10 side bonding pad 10 is circular for convenience in the above embodiments, it may be rectangular or others in accordance with manners of the connection with the suspension side tail terminal. However, if the connection is carried out on the widthwise lateral side of the tail terminal, it is necessary that the bonding pad has a width larger than that of the tail terminal.

As described above, according to the inventive head supporting mechanism of the magnetic disk device or the inventive connecting method for the magnetic disk device, there is an advantage in that the suspension side tail terminal and the bonding pad of the flexible printed circuit board are easily disconnected from each other when the device is to be repaired.

1. A head supporting mechanism for a magnetic disk device comprising:
a magnetic head;
a circuit of the disk device;
a flexible circuit board;
a suspension side wire having a first end connected to a magnetic head and a second end connected to the circuit of the disk device via the flexible circuit board; and
the suspension side wire provided at the second end thereof with a tail terminal disposed to be in surface-contact with a bonding pad of the flexible circuit board and bonded to the latter via a gold ball.

2. A head supporting mechanism as defined by claim 1, wherein a lengthwise front end surface of the suspension side tail terminal is located on the bonding pad of the flexible circuit board, and the gold ball is located on a front end surface of the tail terminal.

3. A head supporting mechanism as defined by claim 1, wherein the suspension side tail terminal is located on the bonding pad of the flexible circuit board while extending in the longitudinal direction, and the gold ball is located on the widthwise end surface of the tail terminal.

4. A head supporting mechanism as defined by any one of claim 1, wherein the gold ball bonding is positioned so as to be bridging the upper surfaces of the suspension side tail terminal and the bonding pad of the flexible circuit board with each other.

5. A head supporting mechanism as defined by claim 1, wherein an open slit is provided at a front end of the tail terminal, and the bonding pad of the flexible circuit board and the tail pad are bonded together at a longitudinal end of the tail terminal via the gold ball bridging the slit.

6. A head supporting mechanism as defined by claim 1, wherein a closed slit is provided at a front end of the tail terminal, and the bonding pad of the flexible circuit board and the tail pad are bonded together at a longitudinal end of the tail terminal via the gold ball bridging the slit.

7. A method for connecting a first end of a suspension side wire, the second end thereof being connected to a magnetic head, to a circuit of a magnetic disk device via a flexible circuit board, characterized in that a tail terminal provided at the one end of the suspension side wire is disposed to be in surface-contact with a bonding pad of the flexible circuit board, and a gold ball is pressed onto a step between the both, while applying a force, slanted toward the tail terminal, to the gold ball relative to the vertical direction of the surface of the bonding pad.

8. A method for connecting a first end of a suspension side wire, the second other end thereof being connected to a magnetic head, to a circuit of a magnetic disk device via a flexible circuit board, characterized in that a tail terminal provided at the one end of the suspension side wire is disposed to be in surface-contact with a bonding pad of the flexible circuit board, and a gold ball is pressed onto a step between the both, while applying a force to a position different from a previously bonded position.

9. A method as defined by claim 8 wherein, when the suspension side tail terminal and the bonding pad of the flexible circuit board bonded together via the gold ball are to be disconnected from each other, the gold ball is mechanically pulled up to release the bonding.
